(19) United States
(12) Patent Application Publication
(10) Pub. No.: US 2026/0298826 A1
(43) Pub. Date: Oct. 1, 2026

(54) LOW-COST LUMINESCENCE LIFETIME IMAGING

(71) Applicant: The Texas A&M University System, College Statin, TX (US)

(72) Inventors: Lakhvir Singh, College Station, TX (US); Alexandra J. Walsh, College Station, TX (US)

(21) Appl. No.: 19/578,322

(22) Filed: Mar. 25, 2026

Related U.S. Application Data
(60) Provisional application No. 63/777,292, filed on Mar. 25, 2025.

(51) Int. Cl. G01N 21/64

(52) U.S. Cl. CPC G01N 21/6456; G01N 21/6408

(57) ABSTRACT

Frequency-domain luminescence lifetime measurements of a sample can be achieved with low-cost optical hardware by encoding lifetime-induced phase shifts between intensity-modulated excitation light and the resulting intensity-modulated luminescent emission in temporally integrated intensities of a doubly-intensity modulated optical signal, and using a machine-learned regression model trained on calibration data to back out lifetime values from intensity measurements. The doubly-intensity modulated optical signal results from application of a second intensity modulation to the combined excitation light and luminescent emission. Modulation frequencies of the excitation and second modulation may be selected to optimize the performance of the regression model.

### CROSS-REFERENCE TO RELATED APPLICATION

This application claims priority and the benefit of U.S. Provisional Patent Application No. 63/777,292, filed on Mar. 25, 2025, which is hereby incorporated herein by reference in its entirety.

### STATEMENT OF GOVERNMENT SUPPORT

This invention was made with government support under Award Number R35 GM142990 awarded by the National Institute of General Medical Sciences (NIGMS) of the National Institutes of Health (NIH). The government has certain rights in this invention.

### BACKGROUND

Luminescence lifetime imaging-a technique that maps the spatial distribution of the average time a luminophore remains in its excited state before emitting a photon—can provide insights into the molecular environment of luminescent (e.g., fluorescent or phosphorescent) molecules. As such, luminescence lifetime imaging finds broad uses in live cell imaging, tissue imaging and characterization, and diagnostics or theranostics (integrated therapy and diagnostics) for disease states. For example, fluorescence lifetime imaging (FLIM) of endogenous fluorophores such as nicotinamide adenine dinucleotide (NADH), flavin adenine dinucleotide (FAD), or tryptophan enables distinguishing between malignant and healthy tissue based on differences in metabolism, and FLIM of exogenous dyes allows quantification of pH or ion concentrations. Phosphorescence lifetime imaging (PLIM) can be used, for example, to assess local oxygen concentrations in vivo and thereby permit mapping of hypoxia, which is a key marker in cancer, or to monitor diabetes or cardiovascular diseases based on measurements of oxygen- or glucose-sensitive lifetimes. Despite their utility, however, FLIM and PLIM have not found widespread adoption and clinical application, owing in part to the typically high cost and complexity of the imaging hardware.

Luminescence lifetime measurements can be acquired either with time-domain systems that measure the decay in luminescent intensity as a function of time from an excitation pulse, or with frequency-domain systems that measure the “phase shift” between intensity-modulated excitation light and the resulting intensity-modulated luminescent emission. Laser scanning microscopy systems can integrate luminescence lifetime measurements in the time domain, using single-photon detection and time-correlated single-photon counting (TCSPC) electronics to build histograms of photon arrival times for fitting and extraction of lifetime values. These systems offer accurate lifetime estimation, high signal-to-noise ratios even under weak luminescence, and the ability to estimate multiple lifetime components. However, in addition to being high-cost, TCSPC systems suffer from slow imaging speeds, which hinder the investigation of dynamic samples or rapid biological events, such as protein-protein interactions, action potential propagation, or intracellular signaling. Wide-field, camera-based microscopy allows for faster luminescence lifetime imaging using time-gating, pulsed sampling, or frequency-domain methods. These techniques, however, are generally limited by hardware sampling rates, low sensitivity, and low photon counts under weak luminescence. In addition, they entail high costs for system hardware, installation, maintenance, and operation.

Accordingly, there is a need for alternative lifetime imaging approaches that avoid or mitigate some of these drawbacks, and extend lifetime measurements to a wider range of research and clinical applications.

### BRIEF DESCRIPTION OF THE DRAWINGS

FIGS. 1A and 1B are block diagrams conceptually illustrating a system for luminescence lifetime measurements and a corresponding calibration setup, respectively, in accordance with various embodiments.

FIG. 2 conceptually illustrates the operating principle by which luminescence lifetime information is converted into measurable intensity information, in accordance with various embodiments.

FIGS. 3A-3C are schematic diagrams illustrating an example system for luminescence lifetime measurements in calibration configuration, sample-measurement configuration in transmission mode, and sample-measurement configuration in reflection mode, respectively, in accordance with various embodiments.

FIG. 4 is a flowchart illustrating a method for calibrating a frequency-domain luminescence lifetime measurement system, in accordance with various embodiments.

FIG. 5 is a flowchart illustrating a method for frequency-domain luminescence lifetime measurements of a sample, in accordance with various embodiments.

FIG. 6 is a block diagram illustrating an example computing machine, in accordance with various embodiments, as may be used to implement computational aspects of any of the systems and methods described herein.

### DESCRIPTION

Described herein are systems and methods for frequency-domain luminescence lifetime measurements—including, in particular, luminescence lifetime imaging—that employ a computational-microscopy approach to convert lifetime-induced phase delays into intensity information, and extract lifetime information from the intensity information using a calibration-based regression model. In various embodiments, a sample is illuminated by intensity-modulated excitation light, resulting in luminescent emission that is intensity-modulated at the same frequency as the excitation light (the “first modulation frequency” or “excitation modulation frequency”), but with a phase shift introduced by the lifetime-dependent delay in emission. The combined excitation and luminescent emission signal, which encodes the phase shift in its intensity modulation, is then further modulated, at a second modulation frequency (or “detection modulation frequency”), to generate a doubly intensity-modulated optical signal that retains phase-shift-dependent intensity information when temporally integrated during measurement with a low-cost (and, compared with the modulation frequency, low-speed) detector, such as a standard camera.

The intensity measurement, or statistical features (such as mean intensity, standard deviation, skewness, and/or kurtosis) derived from a sequence of intensity measurements (e.g., in a corresponding sequence of image frames), can then be mapped onto lifetime values using a machine-learned regression model trained on calibration data in which lifetime values were simulated by controlled optical path-length differences. In the case of spatially resolved intensity measurements in an image of the sample formed on a camera, the lifetime values are likewise spatially resolved, reflecting the spatial lifetime distribution in the sample. The excitation and detection modulation frequencies can be optimized, optionally jointly with the camera exposure time and/or camera frame rate, for predictive performance of the regression model. (As used herein, “optimizing” modulation frequencies and the resulting predictive performance of the model generally refers to selecting combinations of first and second modulation frequencies from a finite or predefined set of candidate frequencies, based on computational or empirical evaluation of predictive performance metrics (e.g., accuracy or stability) and/or metrics linked to predictive performance, to achieve preferred values of the performance metrics (e.g., maximum predictive accuracy), and does not necessarily imply determining a global optimum across all possible frequency combinations.)

Beneficially, the disclosed approach to luminescence lifetime measurement and imaging obviates the need for time-resolved photon detection or phase-locked synchronization between excitation and detection, and can be implemented with inexpensive conventional optical hardware, such as a low-cost diode laser controlled by a function generator to generate the intensity-modulated excitation light, a conventional acousto-optic modulator (AOM) in the detection path to apply a high-speed second modulation, and a low-cost conventional camera or image sensor to temporally integrate the doubly intensity-modulated optical signal.

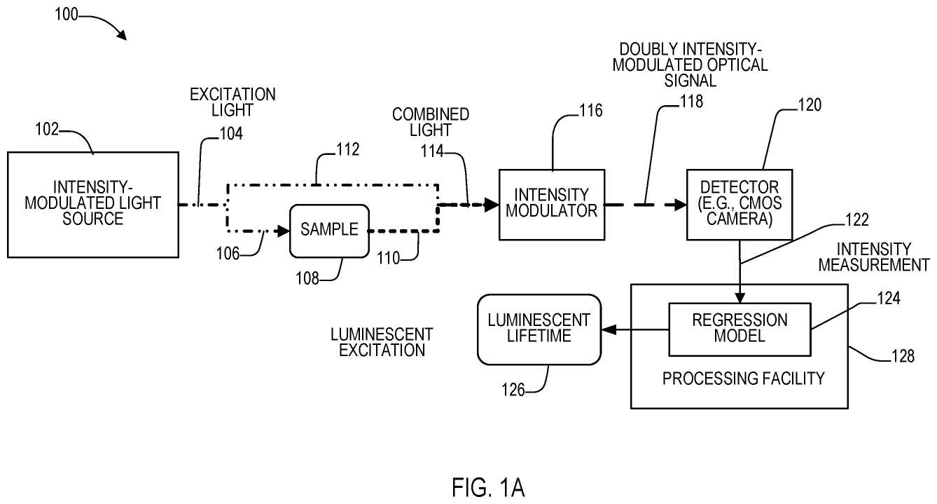

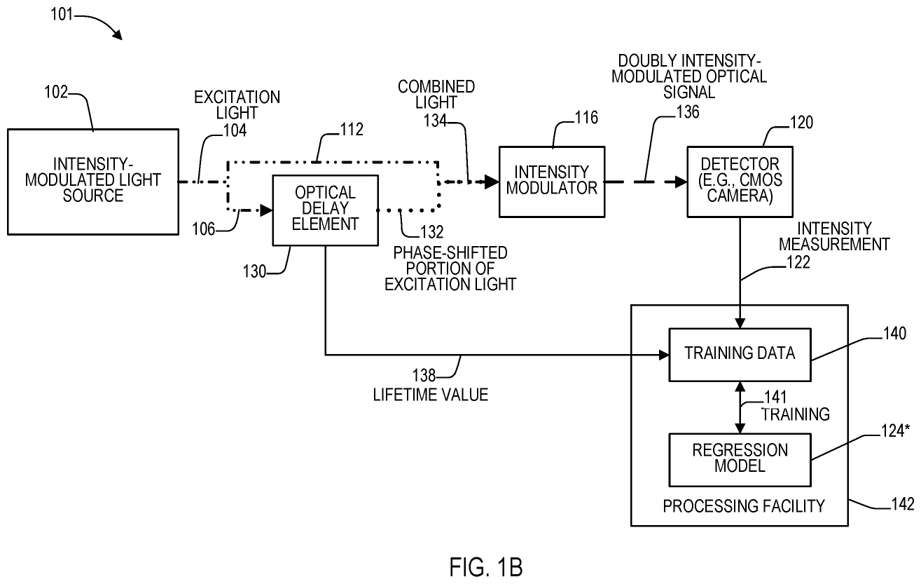

FIGS. 1A and 1B are block diagrams conceptually illustrating a system 100 for luminescence lifetime measurements and a corresponding calibration setup 101, respectively, in accordance with various embodiments. As shown in FIG. 1A, the system 100 includes a light source 102 configured to generate intensity-modulated excitation light 104, in a wavelength range suitable for exciting a desired fluorescence or phosphorescence in the sample. The light source 102 may include, for example, a diode laser or other laser source, a light-emitting diode (LED), or a broadband light source such as an arc lamp or lamp-based illuminator, optionally in combination with one or more optical filters, monochromators, or wavelength-selection elements. The light source 102 may be configured to generate excitation light that is intensity-modulated at a selected excitation modulation frequency by direct electrical modulation of the light source, for example using a function generator, waveform generator, or modulated drive current, and/or by optical modulation using a separate intensity modulator positioned in an excitation path of the light source. To achieve good contrast for lifetime measurements, the excitation modulation frequency is generally selected higher for shorter lifetimes. Thus, for fluorescence lifetimes, which are generally in the nanosecond range, the excitation modulation frequency may be in the range from 1 to 100 MHz, whereas for phosphorescence lifetimes, which are generally in the microsecond to millisecond range, the excitation modulation frequency may be in the range from 1 to a few hundred kHz.

A portion 106 of the intensity-modulated excitation light 104 is directed at the sample 108 and absorbed by luminophores in the sample, causing the sample to emit luminescent light (“luminescent emission”) 110 that exhibits intensity modulation with the same modulation frequency as the excitation light 104, but generally different (e.g., lower) modulation depth and different phase, due to a lifetime-induced phase shift. Another portion 112 of the intensity-modulated excitation light is, depending on the particular system configuration, either transmitted through the sample 108 without interacting with the sample, or routed with suitable optical components along a different optical path, before being combined with the luminescent emission 110 from the sample. The resulting combined light 114 is further modulated, at a selected detection modulation frequency, by an intensity modulator 116 in its path. In various embodiments, the detection modulation frequency is equal to or greater than the excitation modulation frequencies. The intensity modulator 116 may be, e.g., an AOM, electro-optic modulator (EOM), electro-absorption modulator (EAM), or semiconductor optical amplifier (SOA), all of which are generally capable of intensity-modulating a signal at MHz frequencies.

The doubly intensity-modulated optical signal 118 is detected by a suitable detector 120 to provide an intensity measurement 122. For bulk measurements that need not be spatially resolved, the detector 120 may be, e.g., a simple photodiode. For luminescence lifetime imaging applications in accordance with various embodiments, the detector 120 includes an image sensor (i.e., array of sensing elements), such as a complementary metal oxide semiconductor (CMOS) sensor, that provides a spatially resolved measurement. CMOS sensors are commonly used in many standard, low-cost cameras, including, e.g., commercially available compact scientific cameras, which may be suitable for use as the detector 120. (A charged-coupled device (CCD) may in principle also be used, but is generally less desirable due to its significantly higher cost.)

The intensity measurements with the detector 120 inherently integrate the doubly intensity-modulated optical signal 118 over the exposure time of the detector. For instance, standard CMOS cameras with frame rates between ten and hundreds of frames per second (FPS) may have integration times, corresponding to the exposure time within each frame, on the order of milliseconds. As a result, the detector 120 does generally not temporally resolve the intensity modulation of the measured optical signal 118. However, modulation frequencies and exposure time can be jointly configured such that differences in phase shifts between the excitation light 104 and the luminescent emission 110 are encoded, in generally complex and subtle ways, in intensity differences of the integrated signal. The relationship between lifetime-induced phase shifts and intensity measurements can be captured, for a particular configuration of the system 100 and specific modulation frequencies, by training a machine-learning regression model on suitable calibration data. The resulting trained (or “machine-learned”) regression model 124 can then determine, from an intensity measurement 122, a corresponding luminescent lifetime value 126. The regression model 124 is implemented by a computational processing facility 128 using a suitable combination of computing hardware and/or software.

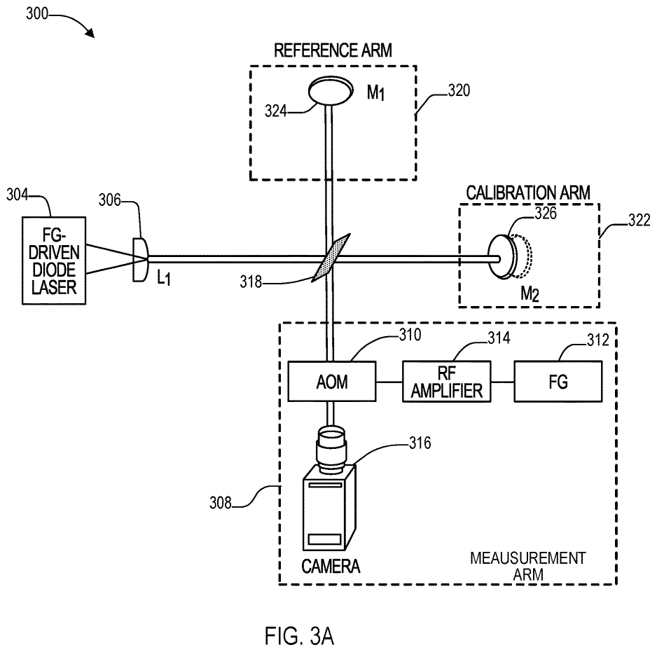

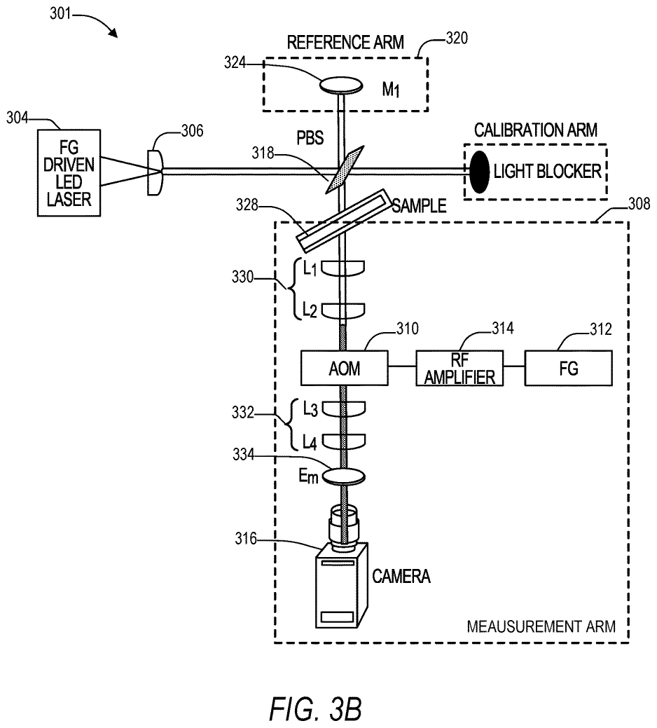

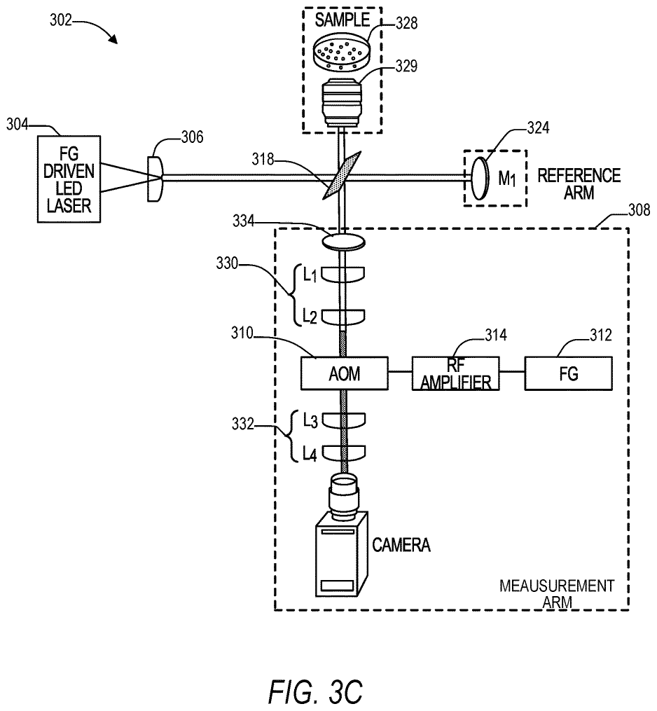

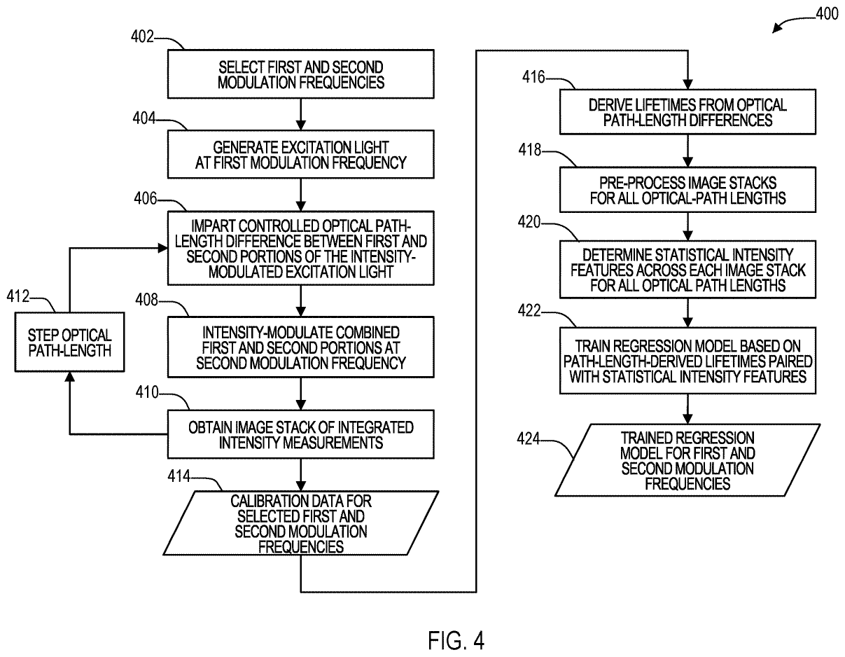

With reference to FIG. 1B, in the calibration setup 101 of the system 100, the sample 108 is replaced with an optical delay element 130 that allows imparting a controlled optical path-length difference between the two portions 106, 112 of the excitation light 104 (e.g., by moving a mirror in a calibration path, as illustrated in FIGS. 3A and 4A) to thereby simulate a lifetime-induced phase shift. The resulting phase-shifted portion 132 of the excitation light is combined with the second portion 112, and the combined light 134 is further modulated, in the same manner as during sample measurement, to generate a doubly intensity-modulated optical signal 136 measurable by the detector 120. The optical path-length difference Δx introduced by the optical delay element 130 causes a phase shift of Δφ=2πfₘΔx/v, where fₘ is the excitation modulation frequency and v is the propagation speed of light in the medium (e.g., in air, approximately c, the speed of light in vacuum). The simulated lifetime t is related to the phase shift Δφ by: τ=(½πfₘ)/tan Δφ. Thus, from the path-length difference Δx, the corresponding simulated lifetime t can be calculated according to:

$$τ = ( \frac{1}{2 π {f}_{m}} ) tan ( \frac{2 π {f}_{m} Δ x}{v} ) .$$

During calibration, intensity measurements 122 by the detector 120 are acquired for multiple values of the optical path-length difference. The range over which the optical path-length difference Δx is varied may be selected such that the above relation between Δx and τ remains approximately linear and yields a single-valued mapping. For instance, in some embodiments, Δx is varied over micrometer-scale distances, e.g., from 10 μm to 100 μm. While the raw lifetimes computed for this small—Δx regime are much smaller (e.g., in the fs regime) than typical luminescence lifetimes of interest, the high linearity of the Δx−τ relationship allows the computed raw lifetimes to be scaled to the desired lifetime range, such as nanosecond or microsecond lifetimes. By applying such scaling to the path-length-derived lifetime values, calibration and regression training for different lifetime regimes can be accomplished without requiring physically large optical delays (e.g., meter-scale path differences that would otherwise correspond to nanosecond lifetimes). In accordance with example embodiments, raw lifetime values computed for Δx ranging from 0 to 100μ are scaled by a factor of about 3.5×10¹³ to allow computations of lifetime values ranging from 1 ns to 11 ns, or by a factor of about 1.2×10¹⁵ to allow computations of lifetime values ranging from 40 μs to 360 μs.

Calibration data including intensity measurements 122 paired with corresponding lifetime values 138 computed from the optical path-length differences (serving as ground truth) constitute the training data 140 for the training 141 the machine-learning regression model 124* (where the * serves to distinguish the as yet untrained model including the adjustable model parameters from the machine-learned regression model 124 with fixed parameters that results from the training). The regression model 124 may be trained by a computational processing facility 142, which may, but need not be the same processing facility 128 as is used during sample measurements.

The machine-learning regression model 124, 124* may be any of a number of models suitable for lifetime inference from intensity measurements, such as, e.g., tree-based models (e.g., a decision tree regressor, random forest regressor, gradient boosted tree), linear or regularized linear models, support-vector regression (SVR) models, Gaussian process regression models, or neural-network-based regressors. In some examples, a tree-based ensemble regressor is used because of its favorable balance of robustness and accuracy for nonlinear experimental data. Both suitable machine-learning model architectures and associated training algorithms are well-known to those of ordinary skill in the art. In accordance with various embodiments, supervised training involves, in brief, providing the intensity measurements 122, or intensity features derived therefrom (e.g., statistical features derived from multiple measurements for the same optical path-length difference), as inputs to the model 124* to generate corresponding predicted lifetime values, and iteratively adjusting model parameters to optimize a cost function that measures the discrepancy between the predicted lifetime values and corresponding ground-truth lifetime values 138.

The processing facility 142 for training the regression model 124* and the processing facility 128 for operating the trained regression model 124 during subsequent sample measurements may each, in general, be implemented using general-purpose computing hardware executing suitable software, special-purpose computing hardware, or a combination of both. General-purpose computing hardware (e.g., provided in the form of a desktop or laptop personal computer or a tablet or smartphone) includes one or more general-purpose hardware processors (e.g., central processing units (CPUs) or graphic processing units (GPUs)) and one or more computer-readable storage media (e.g., including computer memory such as random-access memory (RAM)) storing data and processor-executable program code. Special-purpose computing hardware may include, e.g., a digital signal processor (DSP), field-programmable gate array (FPGA), application-specific integrated circuit (ASIC), or custom electronic circuitry. In some embodiments, the regression model 124, once fully trained, can be represented in the form of a simple look-up table. In other embodiments, the trained regression model 124 (like the model 124* during training) operates programmatically on intensity input to predict lifetime values.

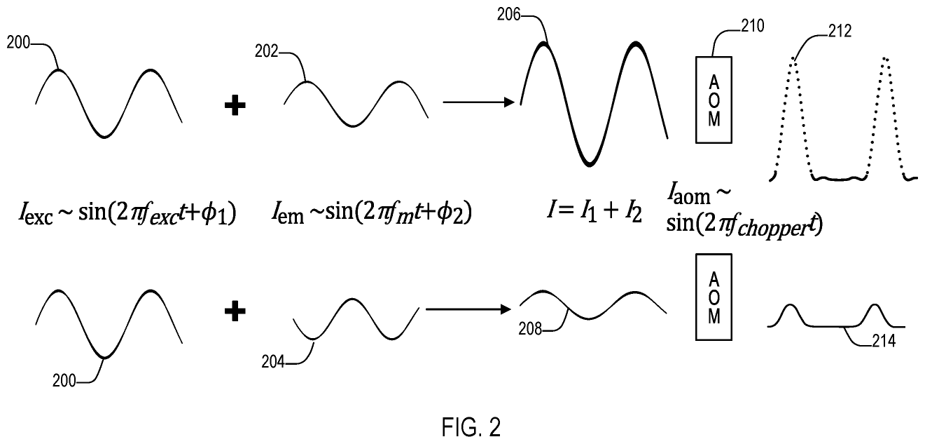

FIG. 2 conceptually illustrates the operating principle by which luminescence lifetime information is converted into measurable intensity information. The combination of intensity-modulated excitation light 200 with intensity-modulated luminescent light 202, 204 is illustrated for two different phase shifts, resulting in different modulation amplitudes of the combined light 206, 208. (For clarity, the constant intensity offset about which the modulation occurs is not shown.) As can be seen, if the intensity-modulated signals are in phase (as for 200 and 202), meaning that the phase shift caused by the luminescence-induced delay or the introduced optical path-length difference is an integer multiple of 21, the signals add constructively, resulting in an increased intensity-modulation amplitude of the combined light 206. Conversely, if the intensity-modulated signals are out of phase by an odd multiple of π (as for 200, 204), the signals add destructively (i.e., subtract), causing a decrease in the intensity-modulation amplitude of the combined light 208, and in the case of equal modulation depths, total cancelation of the amplitude modulation (such that only the constant intensity offset remains). Phase shifts in between 0 and π (modulo 2π) cause corresponding intermediate amplitude values. Thus, lifetime-induced phase shifts between excitation light and luminescent emission are encoded in the modulation amplitude of the combined light. However, direct temporal integration of this high-frequency modulated combined light over realistic exposure times of detectors such as cameras would average out the intensity modulation, yielding the same measured intensity regardless of the underlying phase shift.

This problem can be addressed by further intensity-modulating the combined light, e.g., by an AOM 210 (or other intensity modulator), in a manner that asymmetrically weights different portions of the modulation cycle prior to temporal integration. Conceptually, this weighting can be understood as “chopping” the signal so as to preferentially transmit portions of the modulation cycle associated with higher instantaneous intensities while preferentially attenuating (or blocking) portions associated with lower instantaneous intensities. For illustrative purposes, the idealized chopped optical signals 212, 214 at the output of the AOM 210 depict half-cycle (or half-wave) weighting, in which only signal levels at or above the intensity offset are transmitted while signal levels below the intensity offset are rejected. Under such idealized weighting, the minimum intensity of the chopped optical signal 212, 214 is identical for different phase shifts, while the higher-amplitude intensity-modulated combined light 206 produces larger transmitted intensity peaks, and therefore greater time-averaged intensity, than the lower-amplitude intensity-modulated combined light 208. Accordingly, differences in phase shift are converted into differences in temporally integrated intensity.

In practice, the idealized half-cycle chopping illustrated in FIG. 2 is contingent upon equal, phase-synchronized excitation-modulation and detection-modulation (or chopping) frequencies, or in other words, a phase-locked timing relationship between excitation and detection modulations, which generally entails detector timing capabilities and synchronization that the presently disclosed approach is designed to avoid to lower system cost and complexity. In accordance with various embodiments, the second modulation, applied in the detection path (e.g., by the AOM 210), is not phase-locked to the excitation modulation and does not selectively transmit fixed portions of individual modulation cycles. Instead, the detection modulation operates at a frequency independent of the excitation modulation and multiplicatively combines with the phase-shift-dependent combined light. When the resulting doubly intensity-modulated signal is temporally integrated over a detector exposure period that is long compared to the modulation periods, the time-averaged intensity retains a dependence on the phase shift between excitation and emission. Accordingly, FIG. 2 should be understood as an idealized representation of the manner in which asymmetric temporal weighting of the combined signal is achieved in an effective, time-averaged sense, rather than as a depiction of literal half-cycle or phase-synchronous gating.

In various embodiments, excitation and detection modulation frequencies are selected based on a computational evaluation of candidate frequency pairs to identify combinations that reduce harmonic distortion or noise in lifetime determination. The selected frequencies may then be used during calibration and measurement to optimize the predictive accuracy of the regression model and provide robust lifetime estimation. For purposes of this computational optimization, the time-dependent intensity-modulated excitation signal Iₑₓₑ may be described as:

$${I}_{e x c} ( {I}_{d 1} , {I}_{a 1} , ϕ , T ) = {I}_{d 1} + {I}_{a 1} sin ( 2 π {f}_{e x c} T + ϕ )$$

where I_{d1} is the constant intensity offset of the intensity-modulated excitation signal, Iₐ₁ is the amplitude of its sinusoidal intensity modulation, f_{exc} is the excitation modulation frequency, and φ is the instantaneous phase of the modulated signal (relative to the second modulation signal). The intensity-modulated luminescent emission signal, Iₑₘ, which is modulated at the same modulation frequency f_{exc}, but with a phase difference Δφ=2πfₘΔx/v introduced by the lifetime and modeled by an optical path-length difference Δx for calibration purposes, may be described as:

$${I}_{e m} ( {I}_{d 2} , {I}_{a 2} , ϕ + \frac{2 π Δ x {f}_{m}}{v} , t ) = {I}_{d 2} + {I}_{a 2} sin ( 2 π {f}_{e x c} t ) + ϕ + \frac{2 π Δ x {f}_{m}}{v}$$

where I_{d2} is the constant intensity offset of the intensity-modulated emission signal and Iₐ₂ is the amplitude its intensity modulation. The combined signal, I_{c}, is given by:

$${I}_{c} = {I}_{e x c} ( {I}_{d1} , {I}_{a 1} , ϕ , t ) + {I}_{e m} ( {I}_{d 2} , {I}_{a 2} , ϕ + \frac{2 π Δ x {f}_{m}}{v} , t )$$

The additional sinusoidal modulation applied, with “chopping” frequency f_{chopper}, to the combined signal by the AOM (or other intensity modulator) results in a doubly intensity-modulated signal given by:

$${I}_{final , chopped} = {I}_{c} sin ( 2 π {f}_{chopper} t )$$

Integration of this signal over the exposure time Tₑₓₚ of the camera results in the following camera signal:

$${S}_{a o m} ( t ) = {\int }_{t}^{t + {T}_{exp}} {I}_{final , chopped} dt$$

For comparison, the camera signal resulting from integration of the unchopped signal over the exposure time would result in:

$${S}_{c a m} ( t ) = {\int }_{t}^{t + {T}_{exp}} {I}_{c} dt$$

The above equations can be numerically simulated, e.g., using Python code, for combinations of excitation modulation frequencies (e.g., ranging from 1 kHz to 105 kHz), detection modulation frequencies (e.g., ranging from 20 MHz to 100 MHz in 10 MHz steps) and camera frame rates (e.g., 51, 101, and 151 FPS) and/or exposure times. Such simulations have confirmed that the camera-integrated doubly intensity modulated signal, can discriminate between different phase shifts.

To minimize harmonic distortion of the doubly intensity-modulated optical signal, the following optimization function may be evaluated based on the simulated signals:

$${Q}_{o p t} = \vert {\int }_{0}^{Δ t} {S}_{c a m} ( t ) dt - {\int }_{0}^{Δ t} {S}_{a o m} ( t ) dt \vert - \vert {\int }_{0}^{Δ t} {S}_{c a m} ( t ) dt - {\int }_{0}^{Δ t} {I}_{c} ( t ) dt \vert$$

Herein, the first term captures how the chopped camera-integrated response differs from the unchopped camera-integrated response, and the second term captures how the chopped camera-integrated response differs from the non-integrated, unchopped signal. The optimization function uses the area under the curve of the modulated intensities, calculated using Simpson's Rule, to find optimal modulation parameters. The pair of modulation frequencies f_{exc} and f_{chopper} that achieves the minimum value of Qₒₚₜ provides the least harmonic noise in the lifetime computations (constituting the smallest error).

In one example, to determine optimal frequencies for fluorescence measurements, the optimization-function based error Qₒₚₜ was evaluated for pairs of excitation and detection modulation frequencies, with excitation modulation frequencies f_{exc} ranging from 10 MHz to 80 MHz in 10 MHz increments, and detection modulation frequencies f_{chopper} for each excitation modulation frequency ranging from above that excitation modulation frequency to 90 MHz in 10 MHz increments. The error Qₒₚₜ was found to decrease with an increase in f_{chopper} for fixed f_{exc} as well as with an increase in f_{exc} for fixed f_{chopper}. The optimal frequency pair was frame-rate dependent, and was f_{exc}=80 MHz and f_{exc}=90 MHz for a frame rate of 51 FPS, and f_{exc}=50 MHz and f_{exc}=90 MHz for higher frame rates. To determine optimal frequencies for phosphorescence measurements, the error Qₒₚₜ was evaluated for pairs of excitation modulation frequencies f_{exc} ranging from 1 to 105 kHz (in uneven intervals), and detection modulation frequencies f_{chopper} ranging from 10 MHz to 90 MHz in 10 MHz increments. The error Q opt was observed to decrease with an increase in f_{chopper} and be consistent over values of f_{exc}. The optimal frequency pair was determined to be f_{exc}=70 KHz and f_{exc}=80 MHz.

FIGS. 3A-3C are schematic diagrams illustrating an example system for luminescence lifetime measurements in calibration 300 configuration, sample-measurement configuration in transmission mode 301, and sample-measurement configuration in reflectance mode 302, respectively, in accordance with various embodiments. In this example, the system uses, as the intensity-modulated light source 102, a diode laser 304 emitting excitation light at 530 nm (e.g., Thorlabs M530L3), driven by a function generator (e.g., generating a sinusoidal laser drive signal having a 3V amplitude) to create a sinusoidal intensity variation. The function generator may be selected based on the desired frequency range of the excitation modulation. For instance, a Texas Instruments NI myDAQ function generator controlled by NI ELVISmx software may be used for excitation modulation frequencies from 1 to 5 kHz, and a Hewlett Packard 33 120A function generator may be used for excitation modulation frequencies from 5 to 105 kHz. For even larger excitation modulation frequencies, including MHz frequencies, an AOM at the output of the diode laser 304 may be used instead of a modulated drive signal. The excitation light output by the diode laser may be collimated by a lens system 306 (e.g., using a combination of plano-concave and achromatic doublet lenses) to create a beam with a diameter in the millimeter range (e.g., 3 mm).

The intensity modulator 116 in the measurement arm 308 of the system is implemented by an AOM 310 (e.g., IntraAction AOM-802 R), e.g., operated in Bragg diffraction mode and encoding the modulation in the first diffraction order. The AOM 310 may have an aperture of, e.g., 5 mm×4 mm (suitable to pass the 3 mm beam), and impart an intensity modulation on the order of tens of MHz (e.g., with a center frequency at 80 MHz). The modulated drive signal for controlling the AOM may be generated by function generator 312 such as a voltage-controlled oscillator (e.g., FeelElec FY6900), and amplified by an AOM RF power amplifier 314 (e.g., IntraAction GE RF4030). The doubly intensity-modulated optical signal output by the AOM 310 is measured by a CMOS camera 316 (e.g., ThorLabs CS165MU-Zelux 1.6 mP Monochrome) serving as the detector 120.

In the calibration configuration 300, shown in FIG. 3A, collimated light from the diode laser 304 is split by a beam splitter 318 between a reference arm 320 and a calibration arm 322. The beam splitter 318 may be a polarization beam splitter (PBS) or non-polarizing beam splitter, implemented as a plate-type or cube-type beam splitter, with even (50%/50%) or uneven (e.g., 60%/40%) splitting ratio. (An uneven splitting ratio may be used, e.g., during sample measurements in reflection mode as shown in FIG. 3C, to direct more light through the sample to compensate for the weaker fluorescent emission.) The light in the reference arm 320 is reflected at a fixedly positioned mirror 324 (M₁), whereas the light in the calibration arm 322 is reflected at a linearly translatable mirror 326 (M₂) that facilitates adjusting the optical path length between the beam splitter 318 and the translatable mirror 326, thereby configuring the calibration arm as a controllable optical delay element 130. The reflected portions of light in both arms 320, 322 are recombined at the beam splitter 318, with an optical path-length difference, and thus phase shift, between them that depends on the position of the translatable mirror 326. The translatable mirror 326 may be initially set at the same distance from the beam splitter 318 as the fixed mirror 324, and may then be moved, e.g., in increments of 10 μm, to step the optical path-length difference Δx in corresponding increments of 20 μm.

In the measurement arm 308, the intensity-modulated combined light is further modulated by the AOM 310 and then measured at the camera 316 as a function of the optical path-length difference to provide the calibration data used in training the regression model 124*. In some embodiments, the camera 316 acquires, at a given frame rate (e.g., between 10 FPS and 200 FPS), a stack of (e.g., tens or hundreds of) image frames for each optical path-length difference to enable deriving statistical features of the measured intensity across image frames. Note that, since during calibration, the phase shift between the two portions of light does not spatially vary across the beam, statistics can also be derived across the pixels within a single image frame.

In the transmission-mode sample-measurement configuration 301, shown in FIG. 3B, a luminescent sample 328 is introduced in the measurement arm 308 between the beam splitter 318 and the AOM 310. The sample 328 may be held inside an optically transparent capillary tube (e.g., of soda-lime glass) with a diameter smaller than the beam diameter (e.g., a diameter of about 1.5 mm for a 3-mm beam). During sample measurements, the translatable mirror 326 in the calibration arm 322 is optically blocked, removed, or otherwise effectively excluded, such that only light directed into the reference arm 320 and reflected off the fixed mirror 324 proceeds, through the beam splitter 318, into the measurement arm 308 to illuminate the sample 328. An optical delay is, in this configuration 301, introduced due to the finite luminescence lifetime of the excited sample 328, resulting in a phase shift of the intensity-modulated luminescent emission from the sample 328 relative to the portion of the intensity-modulated excitation light that is transmitted through the sample 328 without being absorbed or otherwise interacting with the sample 328. Note that, for purposes of the sample measurements themselves, the reference arm 320 could be omitted, and the excitation light directly aimed at the sample 328; keeping the reference arm 320 in the sample-measurement configuration 301 serves to implement the same total optical path lengths of the (non-delayed) excitation light between laser 304 and camera 316 during sample measurement as during calibration. Combined light including the transmitted portion of the excitation light and the luminescent light emitted in the same direction as the transmitted excitation light is passed through the AOM 310 and onto the camera 316.

In the reflection-mode sample measurement configuration 302, shown in FIG. 3C, the luminescent sample 328 replaces the translatable mirror 326 of the calibration arm. (Note that, between FIGS. 3A-3B and 3C, reference and calibration arms are interchanged. In FIGS. 3A-3B, excitation light is, at the beam splitter 318, partially reflected into the reference arm and partially transmitted into the calibration arm, but the system would work equally if the calibration arm were to receive the reflected light and the reference arm the transmitted light, as is shown for the reflection-mode system in FIG. 3C.) Excitation light illuminating the sample 328 causes luminescence emission, and the portion of the luminescent emission in the back-reflection direction (i.e., the direction opposite to the direction of the excitation light) is captured, e.g., using an optional lens objective 329, and by the beam splitter 318 combined with the reflection from the fixed mirror 324. The delayed luminescence of the excited sample 328 causes a phase shift between the intensity-modulated luminescent emission from the sample 328 and the intensity-modulated excitation light returning from the fixed mirror 324.

In both transmission mode and reflection mode, the combined light, which includes portions of the excitation light and the luminescent emission, is passed through the AOM 310 and onto the camera 316 using suitable imaging optics. For instance, as shown, a first pair of lenses 330 (e.g., having focal lengths of 75 mm and 100 mm, respectively) placed in the path between the sample 328 and the AOM 310 may be configured to focus the combined light onto the AOM 310 for the second intensity modulation, and a second pair of lenses 332 (e.g., having focal lengths of 25 mm and 50 mm, respectively) placed in the path between the AOM 310 and the camera 316 may focus the doubly intensity-modulated light onto the camera 316 to create, on the camera's image sensor, an image of the sample 328 whose spatial intensity distribution reflects the spatial distributions of luminescence lifetimes in the sample 328. (Although not shown in the calibration configuration 300 in FIG. 3A, which does not include a sample to be imaged, the imaging optics (lens pairs 330, 332) may optionally be included in the calibration configuration 300 for better comparability between calibration and sample-measurement configurations.) Optionally, to selectively attenuate (without completely blocking) the excitation light in the optical signal, a suitable optical filter 334 (e.g., a bandpass filter with larger transmission in the range of 600 nm±40 nm) may be placed in the path between the sample 328 and the camera 316 (e.g., directly in front of the camera as shown in FIG. 3B, or preceding the first pair of lenses as shown in FIG. 3C).

FIG. 4 is a flowchart illustrating a method 400 for calibrating a frequency-domain luminescence lifetime measurement system, in accordance with various embodiments, e.g., using the calibration configuration 300 of FIG. 3A. The method 400 involves collecting calibration data for one or more pairs of a first and second modulation frequencies (i.e., excitation and detection modulation frequencies). For each pair of first and second modulation frequencies (selected in step 402), excitation light is generated at the first modulation frequency (step 404) using a suitable light source (e.g., 304), and split between first and second portions (e.g., using a beam splitter 318). A controlled optical path-length difference is imparted between the first and second portions (step 406), e.g., by translating a mirror 326 in a calibration arm 322 of the system, to simulate a corresponding luminescence lifetime-induced phase shift. The first and second portions are then recombined, and a second intensity modulation at the second modulation frequency is applied to the combined light to produce a doubly intensity-modulated optical signal (step 408). A camera (e.g., 316) is used to obtain an image, or stack of images, each corresponding to a temporally integrated intensity measurement of the optical signal (step 410). The process is generally repeated as the optical path-length difference is stepped through a specified range of optical path-length differences (412) to obtain a calibration data set 414 for the selected first and second frequencies. For example, in some embodiments, the optical path-length difference is stepped from 0 to 100 μm in 10 μm increments.

In a subsequent computational stage, the calibration data set 414 is processed and used to generate a regression model for predicting lifetimes. Processing involves deriving lifetime values from the optical path-length differences to serve as ground-truth values for training the regression model (step 416), as well as determining input features to the regression model from the intensity measurements. Lifetime values are computed according to τ=(½πfₘ)tan(2πfₘΔx/v), and then generally scaled to span a desired lifetime range (e.g., corresponding to fluorescence or phosphorescence. (To determine the input features, in some embodiments, the image stacks are preprocessed (step 418), e.g., by applying intensity-based thresholds to the image stack to exclude pixels that are either saturated or contain insufficient photons (e.g., pixels with intensities below 3% or above 80% of the maximum intensity). Statistical intensity features, such as mean, standard deviation, skewness, and kurtosis may then be extracted from the pre-processed image stack (across the images in the stack and/or across pixels in the image) for each optical path length (step 420). The statistical intensity features, paired with respective path-length-derived lifetime values, are used as input-output training data pairs for training the regression model (in step 422). The regression model may be, e.g., an XGBoost random forest regressor, and may be trained, in one example, with a squared error loss objective function, a learning rate of 0.01, 6000 boosting rounds, a maximum tree depth of 5, a fraction of features to be randomly sampled for each tree of 90%, and an L1 regularization term on weights as 1. Alternative suitable models, training algorithms, and hyperparameters may also be used. The trained regression model 424 can subsequently be used to convert sample measurements taken with the same selection of first and second modulation frequencies into lifetime values.

The process of obtaining calibration data 414 and training a regression model based thereon can be repeated for different combinations of first and second modulation frequencies, and the different models can evaluated for predictive accuracy, stability, or other performance metrics of the regression model. For instance, predictive accuracy may be quantified (e.g., in terms of a coefficient of determination (R²), a mean absolute error (MAE), or a root-mean-square error (RMSE)) based on comparisons between predicted lifetime values and reference lifetime values, such as ground-truth lifetime values derived from the optical path-length differences during calibration, and/or empirical lifetime values independently determined using established methods of measurement. Among the regression models for various combinations of first and second modulation frequencies, the model with the best performance (e.g., highest predictive accuracy) and the corresponding pair of first and second modulation frequencies can be selected for use in sample measurements. For fluorescence vs. phosphorescence imaging, which generally utilize different excitation modulation frequencies matching their very different luminescence lifetime regimes, separate respective optimal pairs of first and second modulation frequencies may be selected. Alternatively to selecting a pair of frequencies, in some embodiments, trained regression models 424 for a given excitation modulation frequency may be averaged over multiple different detection modulation frequencies, e.g., filtered to retain only high-performing models (e.g., models with R² scores above 0.8) to obtain a more robust model. Further, it is in principle also possible to train a regression model jointly for various combinations of modulation frequencies, using these modulation frequencies as inputs to the regression model alongside the intensity features.

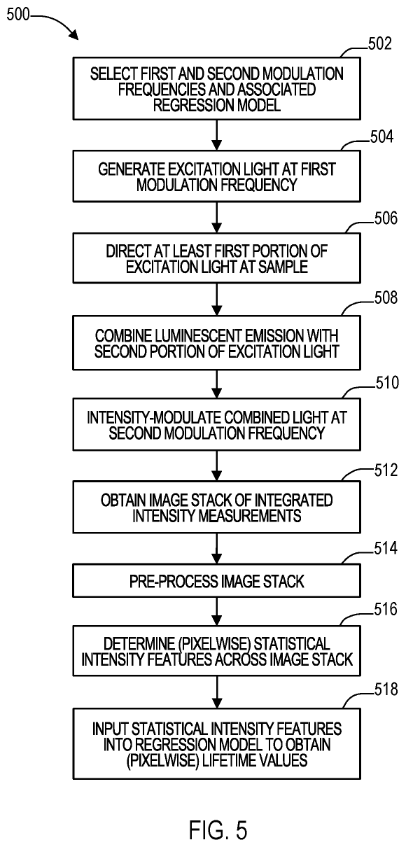

FIG. 5 is a flowchart illustrating a method 500 for frequency-domain luminescence lifetime measurements of a sample, in accordance with various embodiments, e.g., using either of the sample measurement configurations 301, 302 of FIGS. 3B and 3C. The method 500 involves selecting first and second modulation frequencies along with a regression model trained for the selected frequencies (step 502). The selection may depend on whether the sample is fluorescent or phosphorescent, and may serve to utilize a regression model with optimal predictive accuracy, e.g., as determined computationally based on an optimization function or empirically based on measured predictive accuracies of models trained for multiple pairs of first and second modulation frequencies. Excitation light that is intensity-modulated at the first modulation frequency is generated (step 504) by a suitable light source (e.g., 304), and at least a first portion of the excitation light is directed at the sample (e.g., 328) (step 506) and absorbed by the sample, causing an intensity-modulated luminescent emission. The luminescent emission from the sample is combined with a second portion of the excitation light (step 508). In transmission mode, the second portion may be the portion of the excitation light directed at the sample that is transmitted through the sample without contributing to the luminescence. In reflection mode, the second portion may be a portion of excitation light that passes through a reference path without ever going through the sample. In either case, the combined light is further intensity-modulated at a second modulation frequency to generate a doubly intensity-modulated optical signal that depends on a lifetime-induced phase shift between the intensity-modulated excitation light and the intensity-modulated luminescent emission (step 510). A camera (e.g., 316) is used to obtain an image, or stack of images, corresponding to temporally integrated intensity measurements of the optical signal (step 512). Imaging optics in the path between the sample and the camera may be used to form, from the doubly intensity-modulate light, an image of the sample on the image sensor of the camera, thereby spatially resolving the measurements.

To derive lifetime measurements from the image stack, the image stack may be pre-processed (step 514), e.g., to exclude pixels with intensities below a small threshold fraction, e.g., 0.8%, of the maximum intensity. Statistical intensity features (such as mean, standard deviation, skewness, and kurtosis—the same features as computed during calibration) may be computed across the image stack (step 516). To spatially resolve lifetime measurements based on spatially resolved intensity measurements, the statistical intensity features are calculated across the stack separately for each pixel. The statistical intensity features may be provided as input to the selected regression model to obtain, as output of the model, an associated spatially resolved lifetime measurement, such as a lifetime value for each pixel (step 518). Lifetime values may be confined to a reasonable range by setting lower and upper thresholds of, e.g., 0 μs and 2000 μs, respectively. In some embodiments, any system-dependent bias in lifetime computations is corrected for by subtracting, from the lifetime value τ(x,y) for each pixel, a reference lifetime value τ_{ref} that was computed from a reference image stack acquired during calibration for a path-length difference of zero. Alternatively, the bias correction can be implemented by subtracting the reference image stack representing the path-length difference of zero from all other image stacks during both calibration and sample measurements.

The disclosed approach to luminescent lifetime imaging employs conventional optical hardware (e.g., an AOM and a conventional camera) to provide high-speed, low-cost intensity measurements that are convertible to luminescence lifetime values using optical path-difference analysis in conjunction with machine-learning regression. Beneficially, the lifetime system is compact and cost-effective, and facilitates measuring a broad range of lifetimes by leveraging a known relation between optical path-length differences and luminescence lifetime values, thereby enabling calibration scaling for both phosphorescence and fluorescence. Further, the system does not require explicit retuning of detection parameters for consecutive sample measurements, improving usability in clinical settings and increasing its potential for clinical adoption. Additionally, unlike traditional fluorescence lifetime imaging system, the system can, in some embodiments, achieve imaging speeds and throughputs sufficient to support applications in, for example, cell sorting, cell cycle analysis, immunophenotyping, and other key biochemical and biophysical measurement and diagnostic applications. The system is further suitable for commercialization as a clinical diagnostic tool capable of generating contrast between diseased and healthy tissue at an affordable price, and has the potential to enable real-time luminescence lifetime imaging of biopsy or tissue samples, thereby improving access to label-free, non-destructive tissue-health monitoring. For these reasons, the disclosed system can substantially increase the range of research and clinical applications of luminescence lifetime imaging.

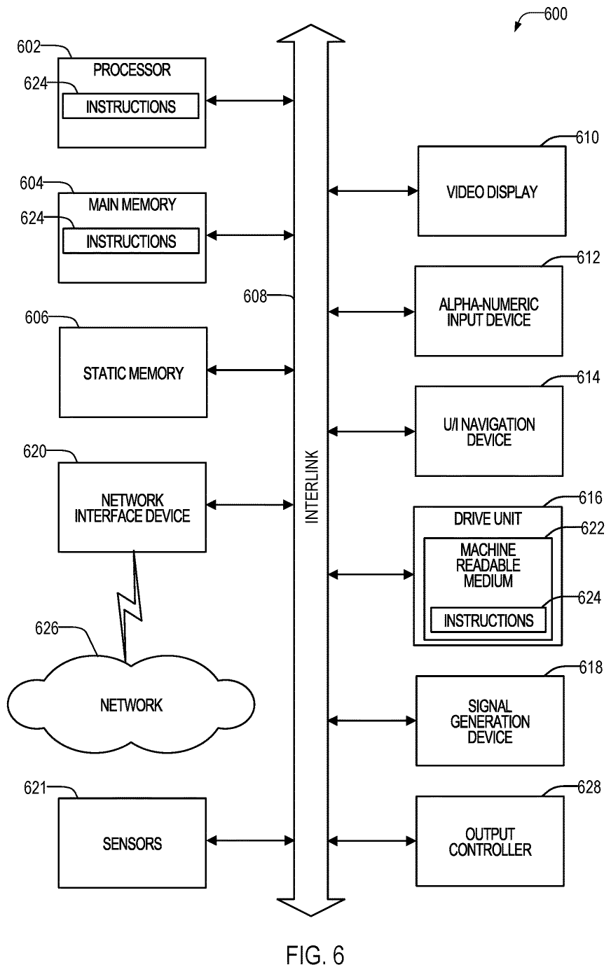

FIG. 6 is a block diagram illustrating an example computing machine, in accordance with various embodiments, as may be used to implement the computational aspects of any of the systems and methods described herein, including the processing facilities 128, 142 for operating and training the regression model 124, 124*, as well as the computational optimization of modulation frequencies. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be, for example, a personal computer (PC), a tablet PC, a personal digital assistant (PDA), a smartphone, a server computer, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations. In various embodiments, multiple machines 600 are used jointly for distributed implementations of methods of training machine-learning models and optimizing weight updates as discussed herein.

Machine (e.g., computer system) 600 may include one or more hardware computer processors 702 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a computer-readable medium 622 on which are stored one or more sets of data structures or instructions 624 (e.g., software) embodying or utilized by any one or more of the techniques or functions described herein. The data and/or instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute computer-readable media. While the computer-readable medium 622 is illustrated as a single medium, the term “computer-readable medium” may include a single medium or multiple media (e.g., a centralized or distributed database, and/or associated caches and servers) configured to store the one or more instructions 624.

The term “computer-readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting computer-readable medium examples may include solid-state memories, and optical and magnetic media. Specific examples of computer-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, computer-readable media may include non-transitory machine readable media. In some examples, computer-readable media may include computer-readable media that are not a transitory propagating signal.

The instructions 624 may further be transmitted or received over a communications network 626 using a transmission medium via the network interface device 620. The machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a computer-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense.

What is claimed is:

1. A system for frequency-domain luminescence lifetime measurements of a sample, the system comprising:
a light source configured to generate excitation light that is intensity-modulated at a first modulation frequency, at least a first portion of the excitation light being directed at the sample and causing an intensity-modulated luminescent emission from the sample, and at least a second portion of the excitation light not contributing to luminescence of the sample;
an intensity modulator, placed in a path of combined light comprising the intensity-modulated luminescent emission and the second portion of the intensity-modulated excitation light, configured to further intensity-modulate the combined light at a second modulation frequency;
a detector to temporally integrate the doubly intensity-modulated optical signal to provide an intensity measurement that depends on a lifetime-induced phase shift between the intensity-modulated excitation light and the intensity-modulated luminescent emission; and
a computational processing facility configured to use a machine-learned regression model to determine, based on the intensity measurement, a lifetime measurement of the sample.

2. The system of claim 1, wherein the detector comprises an image sensor, the system further comprising imaging optics configured to create, from the doubly intensity-modulated optical signal, an image of the sample on the image sensor, such that the intensity measurement and the lifetime measurement determined therefrom are spatially resolved.

3. The system of claim 1, configured to measure the luminescent emission in transmission mode, wherein the second portion of the excitation light is excitation light transmitted through the sample.

4. The system of claim 1, configured to measure the luminescent emission in reflection mode, the system further comprising a beam splitter configured to split the excitation light into the first and second portions, and to combine the luminescent emission with the second portion to form the combined light.

5. The system of claim 1, wherein the intensity modulator comprises at least one of an acousto-optic intensity modulator, an electro-optic intensity modulator, an electro-absorption modulator, or a semiconductor optical amplifier modulator.

6. The system of claim 1, further comprising an optical delay element in a calibration arm of the system, optically excluded during sample measurements, the optical delay element configured to impart a controllable optical path-length difference that simulates a luminescence lifetime-induced phase shift between portions of the intensity-modulated excitation light during calibration of the system in the absence of the sample.

7. The system of claim 1, wherein the regression model has been trained on training data acquired by calibration of the system in the absence of the sample, the calibration comprising imparting controlled optical path-length differences to simulate luminescence lifetime-induced phase shifts between portions of the intensity-modulated excitation light and acquiring intensity measurements of respective doubly intensity-modulated optical signals resulting from further modulation of the combined portions, the training data comprising the intensity measurements paired with ground-truth lifetime values computed from the optical path-length differences.

8. The system of claim 1, wherein the first and second modulation frequencies have been selected to optimize a predictive accuracy of the regression model.

9. The system of claim 8, wherein the first and second modulation frequencies have been selected computationally based on an optimization function.

10. The system of claim 8, wherein the first and second modulation frequencies are selected empirically based on measured predictive accuracies of regression models trained on calibration data acquired for multiple pairs of first and second modulation frequencies.

11. The system of claim 1, selectively configurable for fluorescence lifetime measurements or phosphorescence lifetime measurements, wherein respective system configurations for fluorescence lifetime measurements and phosphorescence lifetime measurements differ in the first and second modulation frequencies and in the trained regression model.

12. The system of claim 1, wherein the computational processing facility is configured to determine the lifetime measurement by processing a sequence of intensity measurements to compute one or more statistical intensity features across the intensity measurements for input to the regression model.

13. A method for frequency-domain luminescence lifetime measurements of a sample, the method comprising:
generating excitation light that is intensity-modulated at a first modulation frequency;
directing at least a first portion of the excitation light at the sample to thereby cause an intensity-modulated luminescent emission from the sample;
combining the intensity-modulated luminescent emission with a second portion of the intensity-modulated excitation light that has not contributed to luminescence of the sample to produce combined light;
further intensity-modulating the combined light at a second modulation frequency to generate a doubly intensity-modulated optical signal that depends on a lifetime-induced phase shift between the intensity-modulated excitation light and the intensity-modulated luminescent emission;
obtaining at least one intensity measurement that depends on the lifetime-induced phase shift by temporally integrating the doubly intensity-modulated optical signal with a detector; and
processing the at least one intensity measurement to determine a lifetime value associated with the sample, using a machine-learned regression model.

14. The method of claim 13, wherein the detector comprises an image sensor, the method further comprising forming, from the doubly intensity-modulated optical signal, an image of the sample on the image sensor to thereby obtain a spatially resolved intensity measurement, wherein the spatially resolved intensity measurement is processed to determine a spatially resolved lifetime measurement.

15. The method of claim 13, wherein the at least one intensity measurement comprises a sequence of intensity measurements, and wherein processing the sequence of intensity measurements comprises computing one or more statistical intensity features across the sequence for input to the regression model.

16. The method of claim 13, wherein the first and second modulation frequencies are selected to optimize a predictive accuracy of the regression model.

17. A method for calibrating a frequency-domain luminescence lifetime measurement system for use with a sample, the method comprising:
generating excitation light that is intensity-modulated at a first modulation frequency;
imparting controlled optical path-length differences between first and second portions of the intensity-modulated excitation light to simulate respective luminescence lifetime-induced phase shifts;
for each of the optical path-length differences:
combining the first and second portions of the intensity-modulated excitation light to produce combined light,
further intensity-modulating the combined light at a second modulation frequency to produce a doubly intensity-modulated optical signal,
obtaining at least one intensity measurement corresponding to the controlled optical path-length difference by temporally integrating the doubly intensity-modulated optical signal with a detector;
computing ground-truth lifetime values from the controlled optical path-length differences; and
training a machine-learning regression model based on training data comprising the intensity measurements paired with the ground-truth lifetime values.

18. The method of claim 17, wherein the at least one intensity measurement comprises multiple intensity measurements, the method further comprising processing the multiple intensity measurements to compute one or more statistical intensity features across the multiple intensity measurements for input to the regression model.

19. The method of claim 17, further comprising:
computationally selecting the first and second modulation frequencies based on an optimization function to optimize a predictive accuracy of the trained regression model.

20. The method of claim 17, wherein the generating, imparting, combining, further intensity-modulating, obtaining, and training steps are performed for multiple candidate pairs of first and second modulation frequencies, the method further comprising selecting an optimized pair of first and second modulation frequencies among the multiple candidate pairs based on values of a predictive accuracy of the trained machine-learning models.
